(19) United States
(12) Patent Application Publication
(10) Pub. No.: US 2005/0285926 A1
(43) Pub. Date: Dec. 29, 2005

(54) Light source assembly, method of producing light source assembly, and color thermal printer

(75) Inventor: Akira Mizuyoshi, Saitama (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/168,407

(22) Filed: Jun. 29, 2005

(30) Foreign Application Priority Data
Jun. 29, 2004 (JP) 2004-191858

(51) Int. Cl. B41J 2/315

(52) U.S. Cl. 347/212

(57) ABSTRACT

A color thermal printer includes a light source assembly for photo fixation of thermosensitive recording material. Element arrays of plural LEDs emit fixing light in a prescribed wavelength range. Each one lens passes the fixing light from one of the LEDs toward a front. A ring or loop-shaped ridge is formed to project from a connection surface of the lens, and has a ring shape. A tilted surface is disposed outside the same. An element receiving recess is disposed inside for containing at least one of the LEDs. A reflection layer of metal is overlaid on the tilted surface, receives fixing light emitted by a lateral surface of the LEDs and upon entry in the loop-shaped ridge, and reflects the fixing light toward the front. Also, the reflection layer is formed by vapor deposition of a metallic material.

### BACKGROUND OF THE INVENTION

1. Field of the Invention

The present invention relates to a light source assembly, a method of producing a light source assembly, and a color thermal printer. More particularly, the present invention relates to a light source assembly in which actinic energy radiation can be intensified even with a simplified structure, and a method of producing a light source assembly, and a color thermal printer.

2. Description Related to the Prior Art

A color thermal printer is an image forming apparatus for use with color thermosensitive recording material to print a full-color image. The recording material includes a support and three-color thermosensitive coloring layers overlaid thereon for developing cyan, magenta and yellow colors. A thermal head having arrays of heating elements is incorporated in the color thermal printer, and applies heat to the recording material being transported for thermally recording. After thermal recording to the yellow and magenta coloring layers, a photo fixer is driven to apply ultraviolet rays as actinic energy radiation to the recording material. A first and second of the coloring layers are chemically fixed so as not to develop color any further before thermal recording to the second and third of the coloring layers.

According to widely used types of the color thermal printer, a light source or optical energy source in the color thermal printer is a lamp, for example ultraviolet lamp. However, there is a shortcoming in that a long use of the lamp will lower an amount of emitting the ultraviolet rays as actinic energy radiation to decrease efficiency in energy emission. It has been necessary to take a countermeasure for obtaining a sufficient amount of the actinic energy radiation required for photo fixation. For example, a speed of feeding the recording material must be lowered to this end.

Various suggestions have been made for improving the use of the photo fixer. For example, light-emitting diodes (LEDs or UV-LEDs) as energy generating elements are incorporated in the light source or optical energy source. JP-A 62-055973 discloses the light source in which light-shielding ridges are disposed between adjacent ones of the LEDs. Lenses are fitted on tops of the light-shielding ridges for utilizing a diffusing component of the ultraviolet rays as actinic energy radiation from lateral surfaces of the LEDs as effective components. Also, JP-Y 7-044029 discloses the light source having a base board or substrate for mounting the LEDs, and recesses formed in the base board. The LEDs are placed in the recesses. Transparent resin is used to seal the LEDs by adhesion, and also used to form lens portions.

There is a problem in JP-A 62-055973 in that a diffused component of the ultraviolet rays as actinic energy radiation of the LEDs or UV-LEDs cannot be utilized as an effective component by use of the light-shielding ridges. Also, the manufacturing cost according to this technique cannot be low because of separate forms of the light-shielding ridges and the lens. Furthermore, the light-shielding ridges must be precisely positioned before the lens is positioned properly in the assembling process. The assembly is much complicated due to a great number of assembling steps.

The light source or optical energy source of JP-Y 7-044029 has a problem in that recesses are difficult to form in the base board, because wiring patterns are formed on the base board for connection with the LEDs or UV-LEDs. A modified sequence of forming recesses at first, and then forming the wiring patterns later cannot be adapted, because lithographic techniques widely used in the art cannot be utilized. Accordingly, the manufacturing cost according to this document cannot be remarkably low. Furthermore, it is difficult to form lenses with equal shaped in case of forming those from resin. Unevenness occurs in application of actinic energy radiation.

There are further documents disclosing LED light sources, for example, U.S. Pub. No. 2004/119,668 (corresponding to JP-A 2004-186092), JP-A 2002-176203, and JP-A 2004-039695. In U.S. Pub. No. 2004/119,668 (corresponding to JP-A 2004-186092) and JP-A 2002-176203, an LED is embedded in a molded portion, and has shortcomings in a high cost for manufacturing a base board, and occurrence of irregularity in emission. JP-A 2004-039695 has also a shortcoming in a high manufacturing cost, because a reflecting member is originally separate from a base board for a semiconductor device.

### SUMMARY OF THE INVENTION

In view of the foregoing problems, an object of the present invention is to provide a light source assembly in which actinic energy radiation can be intensified even with a simplified structure, and a method of producing a light source assembly, and a color thermal printer.

In order to achieve the above and other objects and advantages of this invention, a light source assembly includes a base board. At least one light-emitting element is disposed on the base board. A lens is secured to the base board and over the light-emitting element. A reflector is formed with the lens, for reflecting light from a lateral surface of the light-emitting element in a direction of illuminating of the light-emitting element.

The lens includes a lens body having a curved lens surface and a connection surface reverse thereto. An element receiving recess is formed in the connection surface of the lens body, for containing the light-emitting element. A tilted surface is disposed about the element receiving recess, and has the reflector.

The tilted surface is defined in an auxiliary recess formed in a connection surface of the lens body and positioned to extend about the lateral surface of the light-emitting element.

The reflector comprises a reflection layer of metal formed on the tilted surface by vapor deposition.

The at least one light-emitting element is disposed in the element receiving recess, and the lens surface is convexly curved.

Transparent material of resin is filled in the element receiving recess, for attaching the lens body to the base board.

Material of resin is filled in the auxiliary recess, for attaching the lens body to the base board.

The at least one light-emitting element comprises plural light-emitting elements of an array positioned to extend in one direction within the element receiving recess, and the lens surface is convex in a peripheral rod form, and extends in a direction along the array.

Furthermore, a positioning portion positions the lens on the base board.

The at least one light-emitting element comprises plural light-emitting elements.

The lens is associated with each one of the light-emitting elements.

In one preferred embodiment, the lens is associated with two or more included in the light-emitting elements.

Furthermore, a plurality of blocks are mounted on the base board, and provided with plural types of light-emitting elements, included in the light-emitting elements, and different in a wavelength by a difference of at least 10 nm. The blocks are so positioned that a block interval thereof is greater than an element interval between the light-emitting element on one of the blocks.

In one aspect of the invention, a light source assembly producing method of producing a light source assembly is provided. At least one light-emitting element is mounted on a base board. A lens is secured on the base board over the light-emitting element, to obtain the light source assembly. The lens includes a lens body having a curved lens surface and a connection surface reverse thereto. An element receiving recess is formed in the connection surface of the lens body, for containing the light-emitting element. A reflector is disposed about the element receiving recess, for reflecting light from a lateral surface of the light-emitting element in a direction of illuminating of the light-emitting element.

An auxiliary recess is formed in the connection surface and positioned to extend about the element receiving recess, and a tilted surface is defined in the auxiliary recess.

Furthermore, a reflection layer of metal is formed on the tilted surface by vapor deposition, to constitute the reflector.

According to one aspect of the invention, a color thermal printer includes an optical energy source assembly, having at least one element array of plural energy generating elements, for emitting actinic energy radiation in a prescribed wavelength range, and for photo fixation of thermosensitive recording material. At least one lens passes the actinic energy radiation from the energy generating elements toward a front thereof. A loop-shaped ridge is formed to project from a connection surface of the lens, has a loop shape, has a tilted surface disposed outside, and has an inner space disposed inside for containing at least one of the energy generating elements. A reflector is secured to the tilted surface, for receiving actinic energy radiation emitted by a lateral surface of the energy generating elements and upon entry in the loop-shaped ridge, and for reflecting the actinic energy radiation toward the front.

The at least one element array comprises plural element arrays, and the plural energy generating elements are arranged two-dimensionally.

The reflector comprises a reflection layer overlaid on the tilted surface.

The loop shape is circular or polygonal, and the tilted surface is conical or pyramidal.

In one preferred embodiment, the lens comprises a cylindrical lens for extending along the element array.

The loop shape is substantially quadrilateral, and the tilted surface is constituted by first, second, third and fourth tilted surfaces. The first to fourth tilted surfaces are combined substantially quadrilaterally, the first and third tilted surfaces extend longitudinally along the element array, and the second and fourth tilted surfaces are shorter than the first and third tilted surface, and are positioned at ends of the element array.

### BRIEF DESCRIPTION OF THE DRAWINGS

The above objects and advantages of the present invention will become more apparent from the following detailed description when read in connection with the accompanying drawings, in which:

FIG. 1 is an explanatory view illustrating a color thermal printer;

FIG. 2 is a top plan, partially broken, illustrating a yellow fixing light source assembly;

FIG. 3 is a cross section, partially broken, illustrating an LED and structures relevant thereto;

FIG. 4 is a top plan illustrating the LED and the structures relevant thereto;

FIG. 5 is a perspective view, partially broken, illustrating one preferred lens extending in one direction;

FIG. 6 is an side elevation, partially broken, illustrating the lens of FIG. 5; and

FIG. 7 is a plan, partially broken, illustrating one preferred light source with three-color LEDs.

### DETAILED DESCRIPTION OF THE PREFERRED EMBODIMENT(S) OF THE PRESENT INVENTION

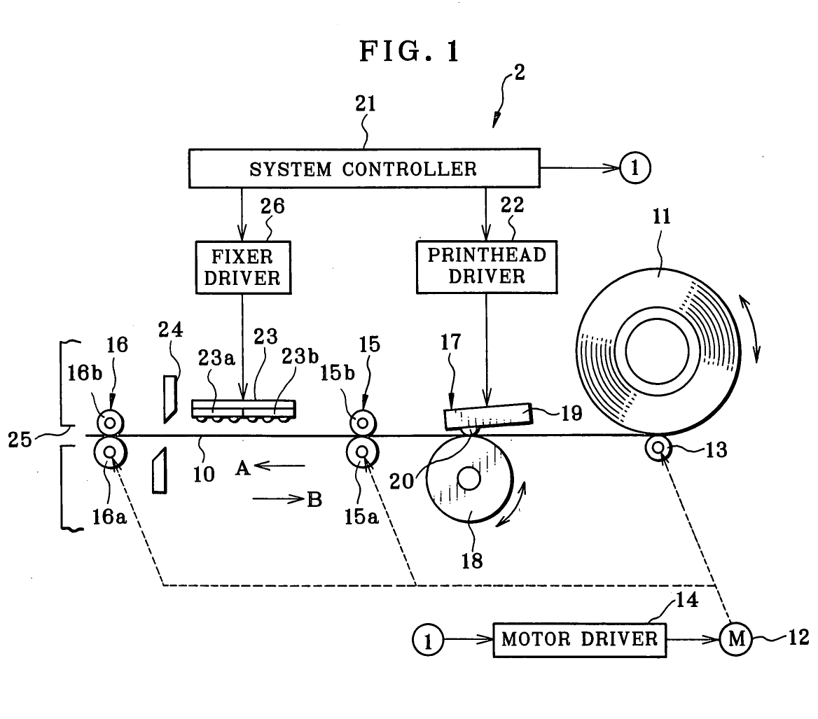

In FIG. 1, a color thermal printer 2 as image forming apparatus of the invention is loadable with a color thermosensitive recording material 10 having photo fixability as photosensitive material of a long form. A recording material roll 11 of the recording material 10 is set into the color thermal printer 2.

The recording material 10 is a known full-color type of three primary colors, including cyan, magenta and yellow thermosensitive coloring layers and a protective layer overlaid on a support. The yellow coloring layer has the greatest heat sensitivity, and develops a yellow color in response to relatively low heat energy. The cyan coloring layer has the smallest heat sensitivity, and develops a cyan color in response to relatively high heat energy.

The coloring ability of the yellow coloring layer is destroyed in response to application of near ultraviolet rays or violet light of 420-450 nm. When heat energy of a middle level is applied, the magenta coloring layer develops a magenta color. The coloring ability of the magenta coloring layer is destroyed in response to application of ultraviolet rays of 365-390 nm. Note that the recording material 10 may have four or more coloring layers, including a black coloring layer.

There is an advancing roller 13 close to a periphery of the recording material roll 11. A feeding motor 12 causes the advancing roller 13 to rotate in contact with the recording material roll 11. The feeding motor 12 is a stepping motor. A motor driver 14 supplies drive pulses to the feeding motor 12 for rotation. When the advancing roller 13 makes counterclockwise rotations in the drawing, the recording material roll 11 makes clockwise rotations, to unwind the recording material 10 from the recording material roll 11. When the advancing roller 13 makes clockwise rotations in the drawing, the recording material roll 11 makes counterclockwise rotations, to wind the recording material 10 back to the recording material roll 11.

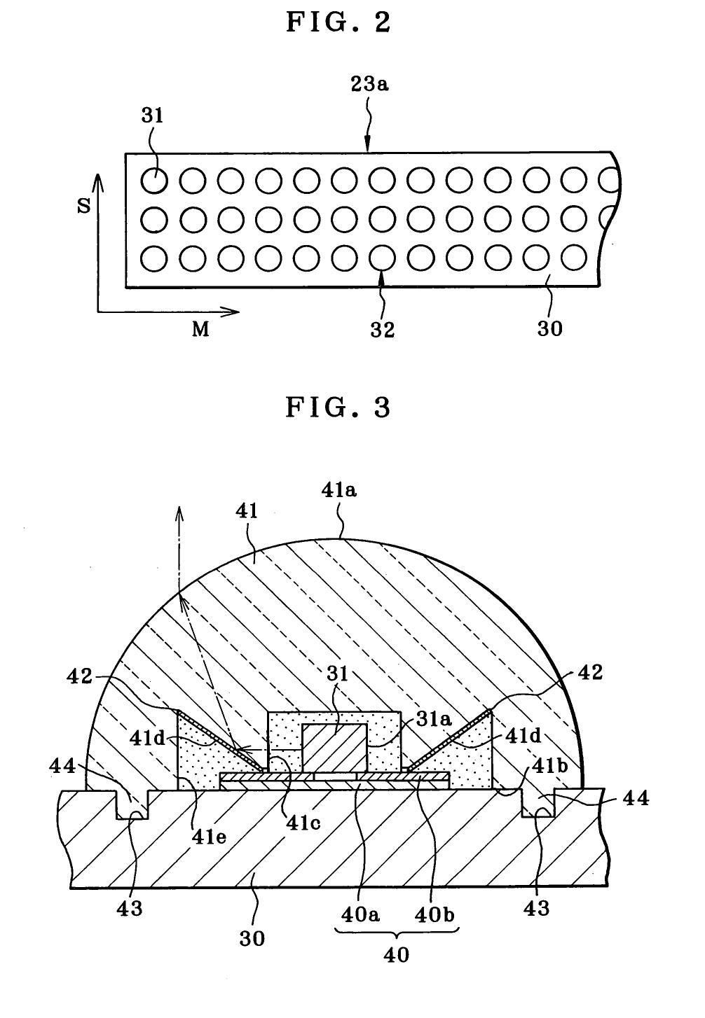

The recording material 10 advanced from the recording material roll 11 is transported to a feeding path extending horizontally. A feed roller set 15 and an ejection roller set 16 are disposed in the feeding path for feeding the recording material 10 in a nipped state. A capstan roller 15a and a pinch roller 15b constitute the feed roller set 15. The capstan roller 15a is rotated by the feeding motor 12. The pinch roller 15b applies pressure in a direction toward the capstan roller 15a. Also, a capstan roller 16a and a pinch roller 16b constitute the ejection roller set 16. The capstan roller 16a is rotated by the feeding motor 12. The pinch roller 16b applies pressure. The plural roller sets 15 and 16 transport the recording material 10 back and forth, namely forwards in a direction A, and backwards in a direction B. For a sub scan direction S of extension of the feeding path, see FIG. 2.

A thermal head 17 is disposed between the advancing roller 13 and the feed roller set 15. A platen roller 18 is disposed lower than a feeding path, and opposed vertically to the thermal head 17. A printhead board 19 of the thermal head 17 has a board surface opposed to the recording material 10. A heating element array 20 is formed on the board surface, and includes plural heating elements arranged in one line extending in a main scan direction M of FIG. 2. A printhead driver 22 is connected with the heating element array 20. A system controller 21 causes the printhead driver 22 to drive the heating element array 20 according to drive data, to develop colors of the coloring layers in the recording material 10.

The platen roller 18 is caused by the transport of the recording material 10 to rotate, to stabilize the contacting state between the recording material 10 and the heating element array 20. Also, the platen roller 18 is movable vertically up and down, and is biased by a spring (not shown) in a direction for pressure to the heating element array 20. At the time of advancing or ejecting the recording material 10, a shifting mechanism (not shown) shifts down the platen roller 18, including a cam, solenoid and the like. So the squeezing of the recording material 10 is released from the thermal head 17.

A photo fixer 23 is positioned downstream from the feed roller set 15 in the direction A, and opposed to a recording surface of the recording material 10. A cutter 24 is disposed between the photo fixer 23 and the ejection roller set 16, and cuts the recording material 10 at a predetermined printing size. An exit channel 25 is formed in the printer body and downstream from the ejection roller set 16 in the direction A, for discharge of the recording material 10 to the outside.

The photo fixer 23 includes a yellow fixing light source assembly 23a as optical energy source assembly, and a magenta fixing optical energy source assembly 23b. The yellow fixing light source assembly 23a emanates near ultraviolet rays with a peak at a wavelength of 420-450 nm, to fix the yellow coloring layer. The magenta fixing optical energy source assembly 23b emanates ultraviolet rays with a peak at a wavelength of 365-390 nm, to fix the magenta coloring layer. A fixer driver 26 drives the photo fixing optical energy source assemblies 23a and 23b.

In FIG. 2, the yellow fixing light source assembly 23a has a base board 30 of aluminum. Element arrays 32, for example three arrays, are formed on the base board 30. Light-emitting diodes (LEDs) 31 as light-emitting elements or energy generating elements are included in each of the element arrays 32, and arranged in the main scan direction M. The LEDs 31 emit near ultraviolet rays with a peak of a wavelength at 420-450 nm.

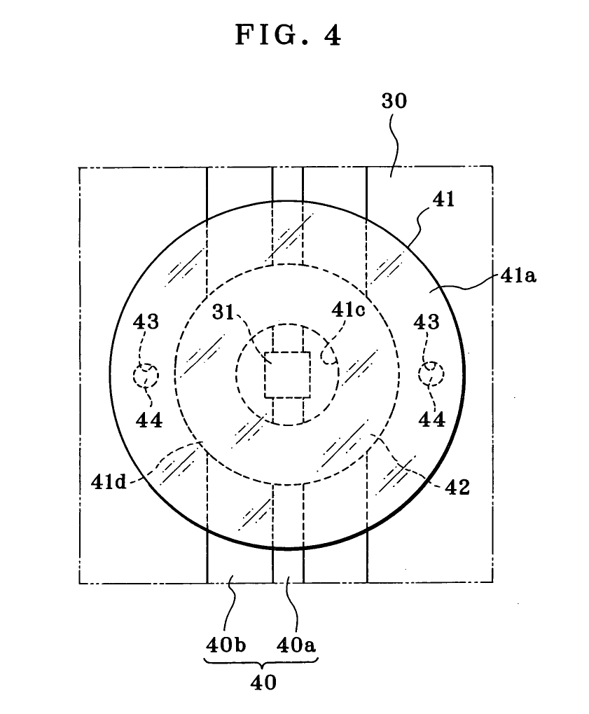

In FIGS. 3 and 4, a printed circuit board 40 is fitted on the base board 30. There is an insulating layer 40a in the printed circuit board 40. A wiring pattern 40b is formed on the insulating layer 40a. The LEDs or UV-LEDs 31 are electrically connected with the wiring pattern 40b by suitable connection, for example soldering, wire bonding and the like.

Lenses 41 are associated with respectively the LEDs or UV-LEDs 31 for imparting optical effects to light emitted by the LEDs 31. Examples of optical effects include diffusion, condensation and the like. A convex surface 41a are hemispherically curved outside each of the lenses 41. Examples of materials for the lenses 41 are glass, acrylic resin, polycarbonate, Zeonex (trade name, manufactured by Zeon Corporation), and the like. The type of each of the lenses 41 may be selected from various suitable types, namely spherical and aspherical lenses.

A connection surface 41b or lens back surface of the lenses 41 is directed to the base board 30 for attachment. An element receiving recess or chamber 41c is formed in the connection surface 41b, and contains the LED 31. An auxiliary recess 41e is formed in the connection surface 41b. A conically spreading tilted surface 41d is defined inside the auxiliary recess 41e, and extends circularly about the lateral surface 31a of the LED 31. Suitable transparent substance as a filling material is filled in the element receiving recess 41c, for example epoxy resin, silicon resin and the like, to attach the lenses 41 to the base board 30 in adhesion. A reflection layer 42 as reflector is overlaid on the tilted surface 41d in a manner of one part together with each lens 41. The reflection layer 42 is a metal deposited by vapor deposition. Examples of metals for the reflection layer 42 include aluminum, silver and the like. The reflection layer 42 is a reflector for reflecting actinic energy radiation from the lateral surface 31a of the LED 31 as indicated by the phantom line of FIG. 3, so as to utilize the same as effective components of actinic energy radiation.

A pair of positioning holes 43 as positioning portion are formed in the base board 30. A pair of positioning projections 44 as positioning portion are formed to project from the connection surface 41b of the lens 41, and fitted in the positioning holes 43. The lens 41 is firmly secured to the base board 30 by engaging the positioning holes 43 with the positioning projections 44. Note that the magenta fixing optical energy source assembly 23b is structurally the same as the yellow fixing light source assembly 23a. No further description will be made for the magenta fixing optical energy source assembly 23b.

The operation of the color thermal printer 2 is described now. At first, a command signal for starting is input. The feeding motor 12 is caused to rotate forwards, to rotate the advancing roller 13 in a counterclockwise direction. The recording material 10 is unwound from the recording material roll 11 in the direction A. A front end of the recording material 10 is transported through the feeding path, becomes nipped by the feed roller set 15, and further moves downstream in the direction A.

When the recording material 10 reaches a starting position, rotation of the feeding motor 12 is stopped in a temporary manner. The platen roller 18 is shifted up by a shifting mechanism, to squeeze the recording material 10 with the heating element array 20. Then the feeding motor 12 is started again in the squeezed state, to transport the recording material 10 in the direction A. The heating element array 20 is driven according to the drive data input by means of the printhead driver 22, and records a yellow image on the recording material 10 in the yellow coloring layer.

When the yellow recording is completed, a rear edge of a recording region is caused to move to a position opposed to the yellow fixing light source assembly 23a of the photo fixer 23. Then the feeding motor 12 is stopped from rotating. The platen roller 18 is shifted down by the shifting mechanism, to release nipping of the recording material 10 from the thermal head 17. The fixer driver 26 causes the LEDs 31 to illuminate in the yellow fixing light source assembly 23a. The feeding motor 12 is controlled to rotate backwards, to wind the recording material 10 back in the direction B. A yellow coloring layer having a recorded image is fixed by photo fixation. Light emitted from the lateral surface 31a of the LEDs 31 is reflected by the reflection layer 42, and becomes incident upon the recording material 10 as effective component of light.

After the yellow recording, the front end of the Recording region of the recording is caused to reach a position opposed to the heating element array 20. Then the feeding motor 12 is stopped. The platen roller 18 is shifted up by the shifting mechanism in a similar manner to the yellow recording, to squeeze the recording material 10 with the heating element array 20. The feeding motor 12 is driven. While the recording material 10 is transported in the direction A, a magenta image is recorded on to the magenta coloring layer of the recording material 10.

When the magenta recording is completed, the rear edge of the recording region is caused to move to a position opposed to the magenta fixing optical energy source assembly 23b of the photo fixer 23. Then the feeding motor 12 is stopped from rotating. In a manner similar to the yellow fixation, the fixer driver 26 causes the UV-LEDs 31 in the magenta fixing optical energy source assembly 23b to illuminate in the magenta fixing optical energy source assembly 23b. The feeding motor 12 is controlled to rotate backwards, to wind the recording material 10 back in the direction B. A magenta coloring layer having a recorded image is fixed by photo fixation. Ultraviolet radiation emitted from the lateral surface 31a of the LEDs 31 is reflected by the reflection layer 42, and becomes incident upon the recording material 10 as effective component of ultraviolet radiation.

After the magenta fixing, the front end of the recording region of the recording is caused to reach a position opposed to the heating element array 20. Then the feeding motor 12 is stopped. A cyan image is recorded on to the cyan coloring layer of the recording material 10 in a similar manner to the yellow and magenta recording.

After image recording, the recording material 10 is transported by the feed roller set 15 in the direction A, and cut by the cutter 24 at a regular printing size. A sheet of the recording material 10 is formed, and ejected by the ejection roller set 16 through the exit channel 25.

This being so, the reflection layer 42 is overlaid on the connection surface 41b of the lens 41. This is effective in reducing their manufacturing cost of parts. As the positioning projections 44 formed on the lens 41 are fittable in the positioning holes 43 in the base board 30, an assembling operation of the photo fixer can be facilitated. The manufacturing cost can be reduced remarkably.

A ratio of the amount of actinic energy radiation emitted by the lateral surface 31a of the LEDs or UV-LEDs 31 has been found 5-25% of the total amount of actinic energy radiation emitted by the LEDs 31. Thus, it is possible to increase the effective actinic energy radiation by 5-25% in comparison with the conventional technique because of forming the reflection layer 42. In conclusion, the time for fixation can be shortened. A photo fixer can be downsized thanks to the reduced number of the LEDs 31. Also, the manufacturing cost can be reduced.

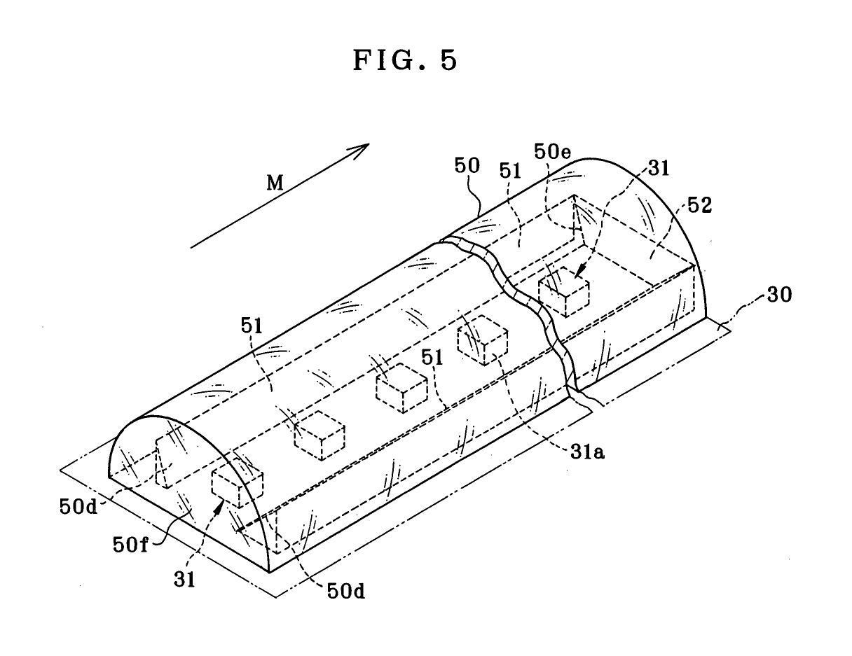

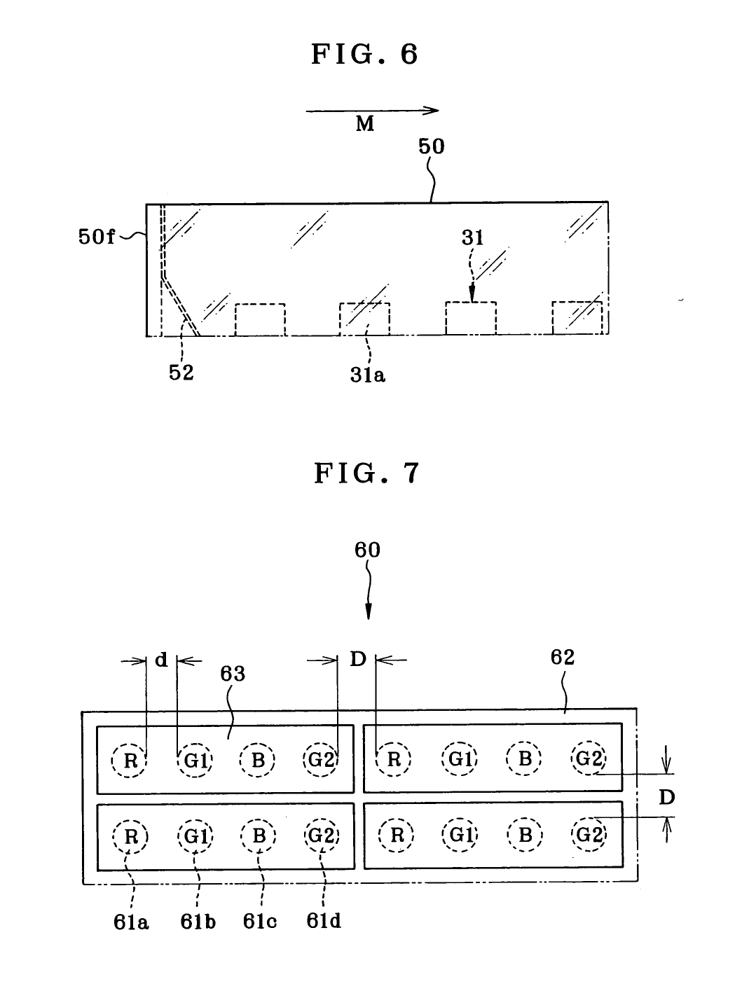

In the above embodiments, the lenses 41 are associated with discretely the LEDs 31. In contrast with this, FIGS. 5 and 6 illustrate a use of a cylindrical lens 50 as lens extending in one direction. Two or more of the LEDs 31 are grouped as a combination, with which the cylindrical lens 50 is associated. The respective combination of the LEDs 31 is formed as a single block for which the cylindrical lens 50 is molded as one piece. Note that the combination may be each one array of the element arrays 32, or any small group obtained by suitably splitting the plurality of the LEDs 31. The lens 50 may be a suitable lens other than the cylindrical lens and having a tubular surface or rod surface.

The cylindrical lens 50 is a rod-shaped lens or cylindrical lens which is defined by splitting a curved surface of a rod shape along a plane extending along the array of the LEDs. A connection surface 50b or lens back surface of the cylindrical lens 50 is directed to the base board 30. An element receiving recess (not shown) is formed in the connection surface 50b, and extends in the main scan direction M. An auxiliary recess 50e is formed in the connection surface 50b. The element receiving recess contains a plurality of LEDs or UV-LEDs 31. A tilted surface 50d is defined by the auxiliary recess 50e. A reflection layer 51 or reflector is overlaid on the tilted surface 50d. In FIG. 6, lateral surfaces 50f lie at end portions of the cylindrical lens 50 as viewed in the main scan direction M. A reflection layer 52 as reflector is overlaid on the lateral surfaces 50f. The reflection layer 52 reflects actinic energy radiation emitted by the lateral surface 31a of the LEDs or UV-LEDs 31 positioned at the lateral surfaces 50f. Therefore, it is possible to prevent the amount of actinic energy radiation from dropping in the vicinity of the lateral surfaces 50f of the cylindrical lens 50. Note that one of the two reflection layers 52 is omitted from FIG. 5 for simplification. The reflection layer 51 is omitted from FIG. 6 for simplification. Also, positioning projections (not shown) are formed on the cylindrical lens 50 in a similar manner to the lenses 41 in a manner fittable in positioning holes in the base board 30. Element receiving recesses are formed in the cylindrical lens 50 for containing the LEDs 31.

In FIG. 7, a white light source assembly 60 is a flat light source as a specific example of the embodiment of FIGS. 5 and 6. The white light source assembly 60 can be used as a backlight of an LCD display panel. The white light source assembly 60 includes a base board 62 and numerous LEDs which are arranged in a matrix, and include a red color LED 61a, a first green color LED 61b, a blue color LED 61c, and a second green color LED 61d. LED blocks are arranged on the base board 62 as LED groups of four LEDs. The red, green and blue colors are defined by differences of 10 nm or more in the wavelength of light. The purpose of the double use of the green color LEDs 61b and 61d is compensation for a low level of the output of easily available green LEDs according to widely used products of today.

A cylindrical lens 63 is associated with each of the blocks of the LEDs. The cylindrical lens 63 is structurally the same as that of FIGS. 5 and 6. Each of the blocks is so positioned that an interval D between those is greater than an interval d between the three-color LEDs 61a-61d. It is possible according to this condition to reduce irregularity in the illumination and color.

A white light source other than the white light source assembly 60 in FIG. 7 may be used in the present invention, for example, construction in which the element receiving recess 41c is filled with transparent resin to which oxynitride phosphor is added. Suitable types of oxynitride phosphor are known from a document, the Japan Society of Applied Physics, Extended Abstracts, Vol. 52, 30a-YH-8. Furthermore, it is preferable to produce a sheet from mixed material with oxynitride phosphor, and to attach the sheet on the LED, or an inner surface of the element receiving recess 41c. This is advantageous in simply constructing the white light source.

In the above embodiment, the element receiving recess 41c is filled with transparent epoxy resin for adhesion. Additionally or alternatively, the auxiliary recess 41e may be filled with resin for adhesion of the lens 41 to the base board 30. Note that the resin for the auxiliary recess 41e may be opaque or translucent, because light from the LEDs 31 does not travel or pass into the auxiliary recess 41e in contrast with the element receiving recess 41c.

Note that the structure for positioning and securing the lens to the base board is not limited to the positioning holes 43 and the positioning projections 44. Any of various structures having suitable shapes, position and portion number can be used.

In the above embodiment, the base board for connection of lenses are a flat board of aluminum. However, a base board may not be flat, for example can have a rod-shaped surface or a cylindrical surface. Also, a base board may have a spherical surface or other curved surfaces. A surface of the base board for connection with lenses can have any suitable shape, for example a pyramidal surface, conical surface, and a combined shape of two or more of a pyramidal surface, conical surface, spherical surface and the like.

Note that the arrangement of the LEDs or UV-LEDs 31 may be patterned in a form not being a matrix. For example, the LEDs 31 can be arranged in a zigzag form in the main scan direction M. The number of the LEDs 31 and the number of the element arrays 32 can be modified suitably with varieties in compliance with the specifications of the color thermal printer 2.

In the above embodiment, the light source assembly or optical energy source assembly of the invention is a photo fixer of the printer. However, a light source assembly or optical energy source assembly of the invention may be an element for an image sensor for use with a telefacsimile, scanner and the like.

For example, it is possible according to the invention to utilize detailed structures of the lens and reflection surfaces disclosed in U.S. Pat. No. 5,001,609 (corresponding to JP-A 2-155279). Also, it is possible in the invention to utilize examples of forming processes of the reflection surface, and apparatuses for image forming according to electrophotography, as disclosed in U.S. Pat. No. 6,577,332 (corresponding to JP-A 11-078115).

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

1. A light source assembly comprising:
a base board;
at least one light-emitting element disposed on said base board;
a lens secured to said base board and over said light-emitting element; and
a reflector, formed with said lens, for reflecting light from a lateral surface of said light-emitting element in a direction of illuminating of said light-emitting element.

2. A light source assembly as defined in claim 1, wherein said lens includes:
a lens body having a curved lens surface and a connection surface reverse thereto;
an element receiving recess, formed in said connection surface of said lens body, for containing said light-emitting element; and
a tilted surface disposed about said element receiving recess, and having said reflector.

3. A light source assembly as defined in claim 2, wherein said tilted surface is defined in an auxiliary recess formed in a connection surface of said lens body and positioned to extend about said lateral surface of said light-emitting element.

4. A light source assembly as defined in claim 3, wherein said reflector comprises a reflection layer of metal formed on said tilted surface by vapor deposition.

5. A light source assembly as defined in claim 4, wherein said at least one light-emitting element is disposed in said element receiving recess, and said lens surface is convexly curved.

6. A light source assembly as defined in claim 5, wherein transparent material of resin is filled in said element receiving recess, for attaching said lens body to said base board.

7. A light source assembly as defined in claim 5, wherein material of resin is filled in said auxiliary recess, for attaching said lens body to said base board.

8. A light source assembly as defined in claim 4, wherein said at least one light-emitting element comprises plural light-emitting elements of an array positioned to extend in one direction within said element receiving recess, and said lens surface is convex in a peripheral rod form, and extends in a direction along said array.

9. A light source assembly as defined in claim 8, wherein transparent material of resin is filled in said element receiving recess, for attaching said lens body to said base board.

10. A light source assembly as defined in claim 8, wherein material of resin is filled in said auxiliary recess, for attaching said lens body to said base board.

11. A light source assembly as defined in claim 1, further comprising a positioning portion for positioning said lens on said base board.

12. A light source assembly as defined in claim 1, wherein said at least one light-emitting element comprises plural light-emitting elements.

13. A light source assembly as defined in claim 12, wherein said lens is associated with each one of said light-emitting elements.

14. A light source assembly as defined in claim 12, wherein said lens is associated with two or more included in said light-emitting elements.

15. A light source assembly as defined in claim 1, further comprising a plurality of blocks mounted on said base board, and provided with plural types of light-emitting elements, included in said light-emitting elements, and different in a wavelength by a difference of at least 10 nm;
said blocks being so positioned that a block interval thereof is greater than an element interval between said light-emitting element on one of said blocks.

16. A light source assembly producing method of producing a light source assembly, comprising steps of:
mounting at least one light-emitting element on a base board; and
securing a lens on said base board over said light-emitting element, to obtain said light source assembly;
wherein said lens includes:
a lens body having a curved lens surface and a connection surface reverse thereto;
an element receiving recess, formed in said connection surface of said lens body, for containing said light-emitting element; and
a reflector, disposed about said element receiving recess, for reflecting light from a lateral surface of said light-emitting element in a direction of illuminating of said light-emitting element.

17. A light source assembly producing method as defined in claim 16, wherein an auxiliary recess is formed in said connection surface and positioned to extend about said element receiving recess, and a tilted surface is defined in said auxiliary recess.

18. A light source assembly producing method as defined in claim 17, further comprising a step of forming a reflection layer of metal on said tilted surface by vapor deposition, to constitute said reflector.

19. A light source assembly producing method as defined in claim 18, wherein in said lens securing step, material of resin is filled in said auxiliary recess, for attaching said lens body to said base board.

20. A light source assembly producing method as defined in claim 18, wherein in said lens securing step, transparent material of resin is filled in said element receiving recess, for attaching said lens body to said base board.

21. A light source assembly producing method as defined in claim 20, wherein said at least one light-emitting element comprises plural light-emitting elements of an array positioned to extend in one direction within said element receiving recess, and said lens surface is convex in a peripheral rod form, and extends in a direction along said array.

22. A light source assembly producing method as defined in claim 16, further comprising a step of positioning said lens on said base board by use of a positioning portion on said lens.

23. A light source assembly producing method as defined in claim 16, wherein said at least one light-emitting element comprises plural light-emitting elements.

24. A light source assembly producing method as defined in claim 23, wherein said lens is associated with each one of said light-emitting elements.

25. A light source assembly producing method as defined in claim 23, wherein said lens is associated with two or more included in said light-emitting elements.

26. A light source assembly producing method as defined in claim 16, wherein said light source assembly further comprises a plurality of blocks mounted on said base board, and provided with plural types of light-emitting elements, included in said light-emitting elements, and different in a wavelength by a difference of at least 10 nm;
said blocks being so positioned that a block interval thereof is greater than an element interval between said light-emitting element on one of said blocks.

27. A color thermal printer comprising:
a base board;
at least one light-emitting element, disposed on said base board, for photo fixation of thermosensitive recording material by applying light thereto after thermal recording;
a lens secured to said base board and over said light-emitting element; and
a reflector, formed with said lens, for reflecting light from a lateral surface of said light-emitting element in a direction of illuminating of said light-emitting element.
